(19) United States
(12) Patent Application Publication
(10) Pub. No.: US 2026/0211531 A1
(43) Pub. Date: Jul. 23, 2026

(54) UNIVERSAL INTERACTION TRANSLATION SYSTEM

(71) Applicant: High Caliber Solutions, LLC, Norfolk, MA (US)

(72) Inventors: Michael Jenkins, Cohasset, MA (US); Sean Kelly, Wakefield, MA (US); Daniel Ferris, Norfolk, MA (US)

(21) Appl. No.: 19/456,206

(22) Filed: Jan. 22, 2026

Related U.S. Application Data
(60) Provisional application No. 63/748,187, filed on Jan. 22, 2025.

(51) Int. Cl. G06F 3/0481; G06F 3/01; G10L 15/22

(52) U.S. Cl. CPC G06F 3/0481; G06F 3/011; G10L 15/22

(57) ABSTRACT

Among other things, a system receives data corresponding to an operating state of a software application. A system identifies, based on the operating state of the software application, data representing a corresponding grid. The system accesses the data representing the grid. The grid comprises a plurality of cells overlaying a spatial region of a window of the application. The grid relates a human-machine interaction associated with a cell of the plurality of cells to a human-machine interaction technique native to the computer system on a spatial sub-region overlaid by the cell. The system receives a human-machine interaction associated with a cell. The human-machine interaction originates from a human-machine interaction technique that is not native to the computer system. The system performs an action in the software application, the action associated with a human-machine interaction technique native to the computer system on the spatial sub-region overlaid by the cell.

### CROSS-REFERENCE TO RELATED APPLICATIONS

This application claims priority to U.S. Application No. 63/748,187, titled Universal Interaction Translation System, filed Jan. 22, 2025, which is hereby incorporated by reference in its entirety.

This invention was made with government support under contract number FA864924P0966 awarded by USAF Research Lab AFRL SBRK. The government has certain rights in the invention.

### BACKGROUND

Soldiers and other personnel working in stressful or fast-changing environments often rely heavily on smartphones for accessing mission critical data like mapping communications and commands through applications such as Android Team Awareness Kit (ATAK) and Special Warfare Awareness Kit (SWAK). But current interface solutions, which may primarily include touchscreens and occasional physical enhancements, such as controller cases for smartphones, may inadequately serve the evolving demands of modern military operations. This produces a gap between software functionality and the ability of personnel to interact effectively with the software, particularly in stressful or dynamically changing environments.

Existing human machine interfaces (HMIs) can either cater to very specific mission requirements or offer broader applicability but still fail to integrate meaningfully, due to high software development costs and limited access for HMI providers to integrate with third party software applications.

### SUMMARY

In some example embodiments, there may be provided a method performed by a computer system, comprising: receiving data corresponding to an operating state of a software application; identifying, based on the operating state of the software application, data representing a corresponding grid stored in a computer memory; accessing the data representing the grid, where the grid comprises a plurality of cells overlaying a spatial region of a window of the software application, where the grid relates a human-machine interaction associated with a cell of the plurality of cells to a human-machine interaction technique that is native to the computer system on a spatial sub-region overlaid by the cell; receiving a human-machine interaction associated with a cell of the plurality of cells of the grid, where the human-machine interaction originates from a human-machine interaction technique that is not native to the computer system; and performing an action in the software application, the action associated with a human-machine interaction technique that is native to the computer system on the spatial sub-region overlaid by the cell.

In some variations, one or more of the features disclosed herein including the following features can optionally be included in any feasible combination. The human-machine interaction technique that is native to the computer system is a touch input. The touch input is a tap, hold, or swipe with one or more digits or stylus. The software application is a mobile application executed on a mobile device. The mobile device is a smartphone or tablet. The operating state of the software application comprises a screen capture image, software accessible operating system or application state information, a global positioning system (GPS) location, a time, or any combination of such. The operating state of the software application is corresponded with the grid using a machine learning model. The machine learning model comprises a computer vision model. The machine learning model comprises a convolutional neural network (CNN). A cell of the plurality of cells of the grid are rectangular in shape. At least a first cell of the plurality of cells of the grid is larger in size than at least a second cell of the grid. The human-machine interaction comprises a use of an input device. The input device is a mouse, keyboard, controller, trackball, tablet, or touchscreen. The human-machine interaction comprises a bodily movement, physiological state, or gesture. The bodily movement or gesture is a hand movement, foot movement, a mouth movement or an eye movement. The human-machine interaction comprises audio. The audio is human speech. The grid is generated via human input to a graphical user interface (GUI). The grid is generated automatically at least in part by performing object recognition on a graphical state of the software application. The operating state of the application is defined via human input to a graphical user interface (GUI). A cell of the plurality of cells is associated with at least two human-machine interactions. At least a first human-machine interaction of the at least two human-machine interactions comprises a bodily movement or gesture, and at least a second human-machine interaction of the at least two human-machine interactions comprises a use of an input device.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates a software-based interaction translation system, in accordance with some implementations;

FIG. 2 schematically illustrates a system hierarchy of grids as they relate to states of an active application, in accordance with some implementations;

FIG. 3 schematically illustrates a deployment of the interaction translation system, in accordance with some implementations;

FIG. 4 schematically illustrates the active application running on three types of client devices in accordance with some implementations;

FIG. 5 illustrates a set of screen captures and of the application translation application, showing functionality for mapping objects on the screen to grid inputs and outputs, in accordance with some implementations;

FIG. 6 illustrates a process flow diagram for performing an action associated with a human machine-interaction technique using an interaction translation system (e.g., the interaction translation system), in accordance with some implementations;

FIG. 7 illustrates screen captures of an ACA mapping process, in accordance with some implementations;

FIGS. 8A-8D illustrate use of an interaction translation application to generate a grid associated with an active application or a state of an application, according to some implementations;

FIG. 9 illustrates screen captures showing the interaction translation application interacting with an active application, in accordance with some implementations; and

FIG. 10 is a block diagram of an example computer system.

### DETAILED DESCRIPTION

A modern HMI solution can integrate various control devices with existing client devices without requiring additional per-application software development or access to proprietary application details or source code. The described system can address this need by functioning as an “HMI amplifier,” enabling any human interface device (HID)-compliant HMI peripheral or solution to control client device applications without requiring further software integration. The system can let users create grids on device screens where each part of the grid can be mapped to inputs from any HMI peripheral following a standard HID protocol, such as a button press, a keystroke, a gesture, or a voice command. When a peripheral input is triggered, the system can simulate a human-machine interaction that is native to the device (e.g., a human-performed action that the device is configured to accept and that is used to control the device or prompt an output or response from the device, such as, for a smartphone, a screen touch) in a corresponding cell. The system can also detect an application that is running and a specific operating state (e.g., a visual state, a time-based state, or a location-based state) the application is in. This can allow operators (e.g., military personnel or medical personnel) to create personalized profiles for different applications that can update automatically as a mission evolves. The system can make it easy for an end user to configure how different peripherals control a user device without the end user needing to write any code to configure the device.

Accordingly, described is a software-based interaction translation system that can extend touch-based software applications to accept input from a wide variety of human-machine interactions, including gestures and inputs from peripheral devices.

To perform this function, the interaction translation system can overlay a grid on an application interface. Each cell in the grid can correspond to a different spatial region (e.g., a portion of the display comprising one or more pixels) of the application interface. Cells can be of uniform size and shape or can be shaped to accommodate various spatial objects of the application's graphical user interface. Once cells have been associated with spatial regions of the user interface, they can be assigned to human-machine interactions that can correspond to touch inputs to their underlying regions. For example, a grid placed over a graphical object can be associated with a press of a keyboard key, a hand gesture, a foot movement, a controller button press, or a mouse click. Any of these example inputs may perform the same action as would occur if this graphical object were to be touched on a smartphone.

The grid may be generated via human input or automatically. For example, the interaction translation system can include an interaction translation application which can enable a user to use a drag-and-drop interface to size and position grid cells. In some implementations, the program analyzes interactive objects from an application's accessibility coding and/or visual objects on an application display and fit a grid to match the configuration of interactive graphical objects.

A particular grid can be associated with a particular operating state (herein interchangeably referred to as a “state”) of the software application. The state can be a graphical state. For example, a particular functionality or sequence of in-application instructions can be associated with a particular arrangement of graphical objects on a display. This graphical state can be associated with a particular grid configured to consider this arrangement of graphical objects. The particular state can relate to a time or location in addition to or instead of the visual state. The system can also use a machine learning model to capture state information and use the state information to predict the state of the software application.

Together, the features of the system can make a wide range of software applications interoperate with a wide range of human-machine interactions, making them more easily usable in diverse environments and situations. The software-based system can make digital tools easier to use when time and space are limited, when emergencies occur, when users face limitations (e.g., as an accessibility solution) or simply have different preferences for how they interact with smartphone applications. For example, the software system can be just as easily deployed in military scenarios, in emergency rooms, or during natural disasters, and within home, vehicle, or office environments.

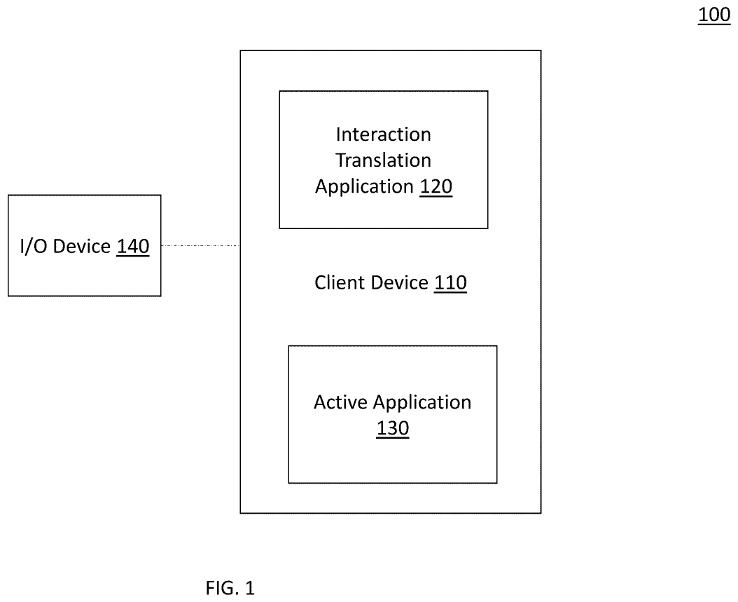

FIG. 1 illustrates a software-based interaction translation system 100, in accordance with some implementations. The software-based interaction translation system 100 includes a client device 110 including an interaction translation application 120 and an active application 130. The software-based interaction translation system 100 also includes an input/output (I/O) device 140. In some implementations, the software-based interaction translation system includes alternative, more, or fewer components.

The client device 110 can be a computing device configured to provide software (e.g., applications or systems, such as operating systems) that can accept one or more types of human interaction as input to control hardware or software functionality. The one or more type of human interaction can include touchscreen input from one or more digits (e.g., a human finger, body part, or stylus), other types of physical gestures that do not contact a screen of the client device 110 (e.g., bodily movements or voice commands), and/or interactions that involve one or more input/output (I/O) devices. The client device 110 can be a mobile device, such as a smartphone, tablet, or personal digital assistant (PDA). The client device 110 can be a wearable device, such as a smartwatch. The client device 110 can be another type of computing device, such as a desktop computer or a laptop computer.

The client device 110 can include one or more active applications 130 that perform tasks needed by an operator conducting a mission or operation. The active applications can include, for example, Android Team Awareness Kit (ATAK) or Special Warfare Awareness Kit (SWAK). The tasks can include manipulating graphical objects on a display of the client device 110 and transitioning between one or more states of an active application 130. An active application 130 can be configured to accept one or more specific types of input from a user, such as voice input, touch input, input from an I/O device, and/or gesture input.

The active application can be associated with a GUI including one or more graphical objects. A graphical object can include an image, a slider bar, an animation, a button object, a command prompt, a visual code, or another visual element of the GUI.

The active application 130 can be usable during active missions or operations in a variety of contexts or environments. The contexts or environments may require that an operator of the client device not be able to use the types of interactions that are native to the client device. For example, the application can be deployed in a military setting where it can be used to control military hardware or direct military operations. In these settings, an operator may not be able to use a touchscreen normally, and may have to use voice commands or gestures, or control the client device using another piece of military hardware instead. The active application 130 can be deployed in an emergency medicine setting. For example, a medical professional actively providing patient care or operating medical equipment may need a hands-free method for using a medical software application.

The active application 130 can be associated with a plurality of states. A state can be visual states. For example, a visual state can be associated with a particular collection of on-screen graphical objects, particular configuration of graphical windows, a particular animation, or a particular color scheme or design layout. In some implementations, the state is associated with time, with particular audio playback, or with a location. For example, the state can be associated with a Global Positioning System (GPS) location. In some implementations, active application 130 is associated with more than one state simultaneously. For example, the active application 130 can be associated with a timestamp and a particular orientation or collection of visual objects. In some implementations, state information is associated with operating system features, consoles, or terminals.

The interaction translation application 120 can generate grids that can be overlaid on active applications (e.g., 130) and allow them to interpret human-computer interactions that are not native (e.g., an action performed by a human that does not effectuate control of the application or the client device by the human, or, when performed, produce an output or response from the device or application) to the application or to the client device 110. A grid can include a plurality of cells. A cell can be, for example, square or rectangular in shape. However, in some implementations the cells are differently shaped. In some implementations, one or more of the plurality of cells differ in size and/or shape from the rest of the plurality of cells. In some implementations, the cells are of uniform size and/or shape. A grid can be associated with a particular state of an active application 130. For example, a grid can be associated with a visual state including one or more graphical objects on a display of client device 110. The interaction translation application 120 can be configured by a user to correspond to a particular state of active application 130. For example, the interaction translation application 120 can include a graphical user interface (GUI) that allows a user to configure the cells of the grid (e.g., by dragging and dropping individual cells or graphical elements). Grids can be modified by adding and removing rows and columns or editing a width and/or a height of a column and/or row. When a column or row is in a correct position (e.g., to ensure the cells are aligned with on-screen content), the row or column can be locked in place so that it does not get adjusted when adding, editing, or removing other rows or columns.

Interaction translation application 120 can allow users to modify grids on a per-application basis (e.g., for an ATAK or SWAK application), or on a per-application, per-view basis (e.g., a SWAK application can have one grid including a map view, another grid for a plugin view, and another grid for an open control view). As a grid is created, the interaction translation system 100 can register which active application 130 is executing and capture a screenshot of the GUI of the active application 130. This can enable the system to detect when the active application 130 is executing, in order to load an appropriate grid or set of grids. When an active application 130 has more than one grid, the interaction translation application 120 can determine which set of grids to apply based on matching an image set to the active application 130. Once any given grid is created, the interaction translation application 120 can assign a human-machine interaction not previously accepted (or native) to the active application 130 or the client device 110 to a cell of the grid. After this is defined, the active application 130 is configured for use with the non-native interaction.

The interaction translation application 120 can allow a user to map human-machine interaction peripheral (HMI-P) inputs to grid cells. In some implementations, a check is performed to determine which HMI-P devices are actively connected to the client device 110 via a communication protocol such as USB-C or Bluetooth. A user can select a human interaction device from among that list or can manually import a new human interaction device. Then, the user can select a cell on the grid. The interaction translation application 120 then can enter into a “listening mode” to detect an HMI-P input (e.g., a mouse clicks, a key stroke, a voice command, or a gesture). The registered input can then be mapped to the cell. A grid can have multiple HMI-P inputs map to it, including within the same cell (e.g., input from two different types of video game controllers could map to a single cell). HMI-P devices can adhere to the human-interface device (HID) protocol or another protocol to send detectable inputs to the interaction translation application 120. Some HMI-P devices can require third-party applications to run on the client device (e.g., a gesture classification app for a data glove) but still can be able to run in the background with the interaction translation application 120 and send out a listener detectable input.

Automated context adaptation (ACA) can be configured to detect when an active application changes an onscreen GUI stage to one aligned with a generated grid. This can allow the interaction translation application 120 to detect which grid should be active to align with GUI elements that a user wants to interact with via HMI inputs. This can be achievable by having a user annotate dynamic aspects of a screenshot of a target GUI state. Each grid can have a single GUI state it is associated with. Each GUI state can be associated with a single annotated screenshot image from the active application. A given active application could have N number of GUI states defined (and n or n+1 grids, adding one for apps that have a grid defined that is GUI state-agnostic). This can limit the search space to only ACA GUI states that exist for the detected active app application. When the ACA detects a GUI state, the interaction translation application 120 can remain as the active state before the grid is automatically switched to that GUI state. This can be configured in user preferences.

With the grids configured, a user can add and map any HID compliant HMI to interact with the active application. For example, a gamepad, mini-keyboard, gesture controller, or a speech to text HMI could all be added to the interaction translation system 100 to be available for use. This process can be done on the client device 110. For example, the system can use a HID listener to detect when a peripheral is connected or run it. When a user performs interactions with the device, an accessibility service can then be used to capture the event signals based on the HID protocol after the set of inputs are captured by the system. A user can then map the inputs to specific grid keystrokes. For example, on an application basis or a grid basis, completing the configuration mapping. Once this is completed, the system will be able to detect when the HID is connected and know how to route input commands from the device to the appropriate grid cell given the application or screen or state that is active to execute the emulated have screen press or other acceptable device input achieving the user's desired action.

In some implementations, the interaction translation application 120 uses computing methods for generating the grid. For example, the interaction translation application 120 can process an operating state of the application, such as a visual state, using a computer vision process or a machine learning model. The machine learning model may include, for example, a convolutional neural network (CNN) that is trained to interpret a visual state and determine, based on the visual analysis, placement of grid cells.

The input/output (I/O) device 140 can be a device that allows an end user to interface with the client device 110. The I/O device 140 can allow the user to provide instructions to the client device 110, and receive output signals, such as changes in display, sounds, or other signals, from the client device 110. Example input output devices include mice, keyboards, cameras or optical sensors, trackpads, track balls, video game controllers, haptic sensors, or microphones. In some implementations, multiple I/O devices are connected to the client device 110 simultaneously. The I/O device can communicate or be coupled electronically to the client device 110 using a wired or wireless connection. For example, the I/O device 140 can be connected using Wi-Fi or Bluetooth. In some implementations, the I/O device communicates with the client device 140 over a network.

In some implementations, the interaction translation system 100 is configured to accept an input based on a measurement of a physiological state of a user. For example, a signal from a heart rate monitor can cause the active application 130 to activate a graphical object that dials an emergency number. In some implementations, the interaction translation system 100 is configured to accept input from an environmental sensor. For example, signals from an environmental sensor can cause the active application 130 to activate a graphical object that can lock touch controls when the client device 110 is vibrating, activate a graphical object that can adjust a volume based on a sensing of ambient noise, or activate a graphical object that can adjust brightness based on a sensing of ambient brightness.

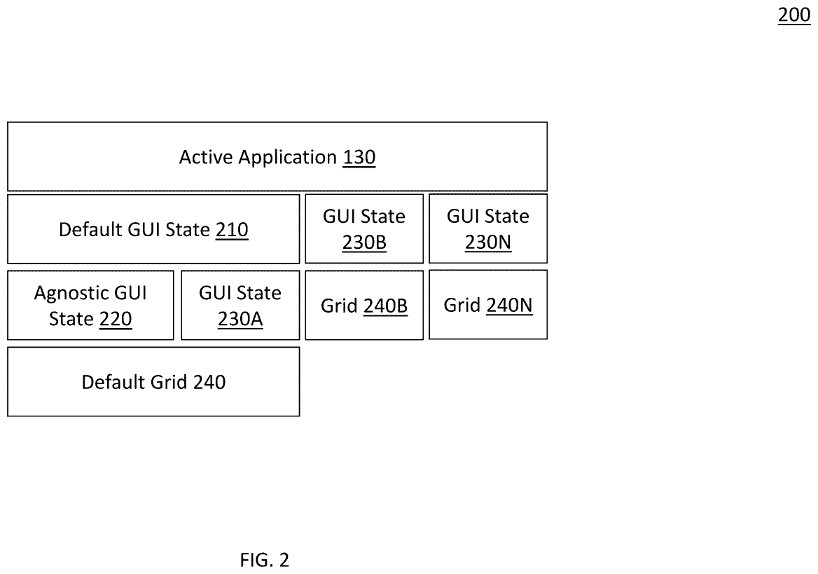

FIG. 2 schematically illustrates a system hierarchy of grids as they relate to states of active application 130, in accordance with some implementations. A grid is associated with a state of the active application 130. A user can optionally define any combination of application states and assign an associated grid. In some cases, a grid can be configured to be presented during multiple application states. For example, a user may want to have a generic grid always visible within a particular active application. In this case, the user would not define an image-based GUI state, but instead would define a default grid 240 used agnostically (e.g., regardless of the active application's GUI state). There can be two types of default grids-ones that exist outside applications (e.g., grids that could be used to select an application icon, or activate another function, such as a “back” or “previous page” command). These can turn off when an application is launched or is executing in the foreground, but could remain active during runtime of the application or while a device is online. For example, default grid 240 can be used with default GUI state 210 (being active when no other grids are active), for agnostic GUI state 220 (being used when no other registered GUI states are detected), or GUI state 230A (being active when other grids are active). Hence, default grids (e.g., 240) can be used to set up inputs for an application's main menu, navigation controls, or other features that can persist across different GUI states. In other cases, a user may want to define a grid that only applies to a particular GUI state. In this case, the user would define only the GUI state and associated grid with no default set. they would only be able to control the application with the interaction translation system 100 when the specific GUI state is detected by the system. In another implementation, the user might want to define a default grid (e.g., default grid 240) along with one or more GUI state-specific grids (e.g., grids 230B-N associated with states 230B-N). In this case, the GUI-specific grids would take over when detected but in all other cases, the default grid would be activated.

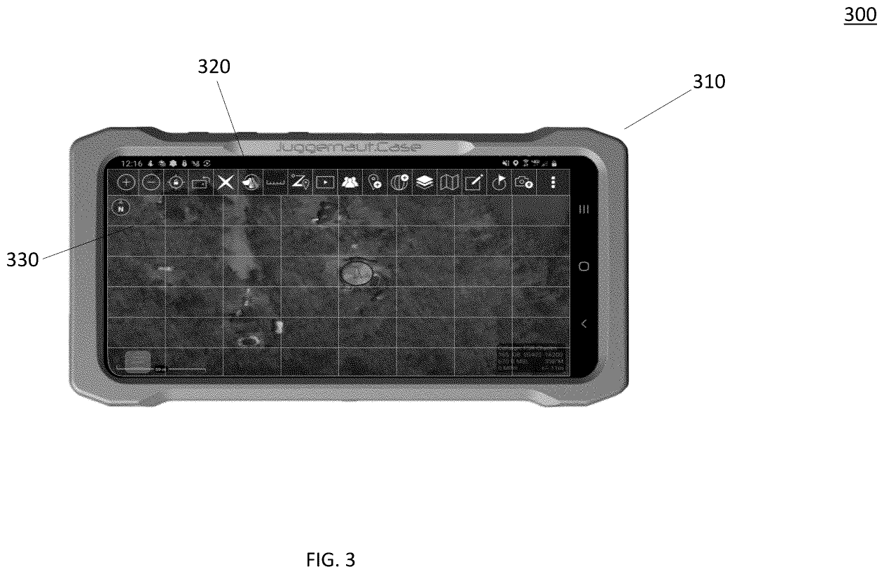

FIG. 3 schematically illustrates a deployment 300 of the interaction translation system 100, in accordance with some implementations. In the deployment 300, a grid 330 is overlaid on an active application of client device 310. In the deployment 300, client device 310 is a ruggedized smartphone. The active application of client device 310 is a mapping application including a plurality of graphical objects. The graphical objects include topographical features, such as elevated surfaces, geological features, and greenery. The active application also includes a menu of graphical buttons (e.g., 320) displayed at the top of the display. The cells of grid 330 are different sizes to accommodate the different graphical objects on the display. For example, the cells at the top of the display are smaller and square in shape to accommodate the identically sized buttons, but the cells underneath the buttons are rectangular in shape and larger in order to accommodate the topographical features. The active application of client device 310 can be configured to accept a touch screen input. Grid 330 can associate screen touches with human-machine interactions not native to client device 310 or the active application executing on it. For example, grid 330 can allow certain cells to be associated with clicks, voice commands, gestures that are recorded by a camera, inputs from peripheral devices such as keyboards, mice, and microphones, or other gestures. A cell of grid 330 can include a mapping of one or more types of input interactions to the touchscreen input of client device 310. For example, a person can say “Exit,”, which would be mapped to touching the “Exit” button. A user can perform a bodily movement, which, when registered by the active application, could have the effect of two-finger scrolling to view different portions of the onscreen map. Bodily movements can include movements such as such as hand movements, leg movements, torso movements, trunk movements, head movements, or facial movements (e.g., eye or mouth movements).

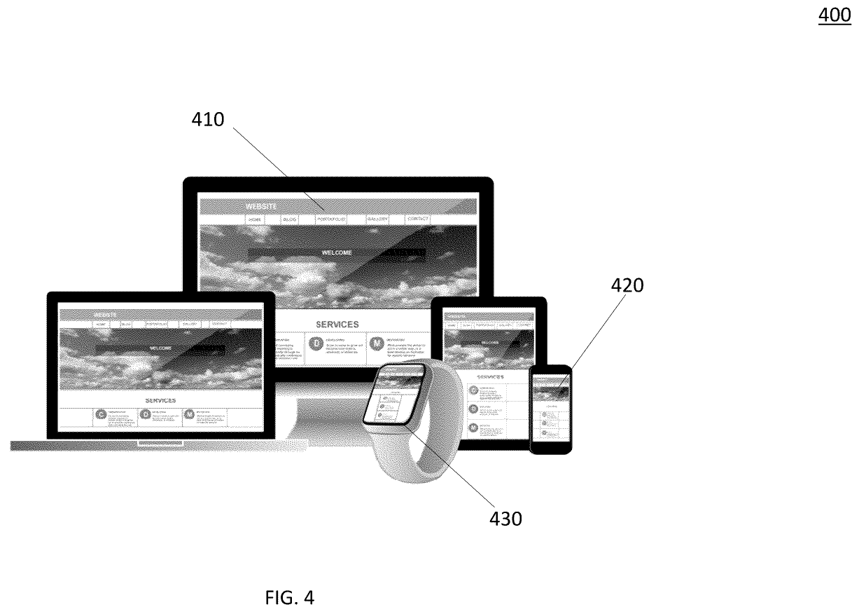

FIG. 4 schematically illustrates the active application running on three types of client devices in accordance with some implementations. The application is shown running on a smart watch 430, a smartphone 420, and a desktop computer 410.

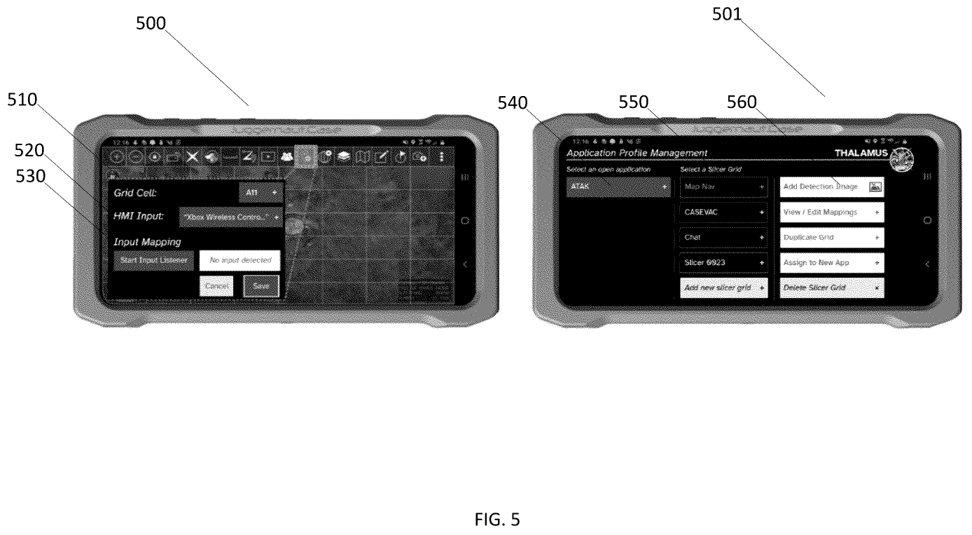

FIG. 5 illustrates a set of screen captures 500 and 501 of the application translation application 120, showing functionality for mapping objects on the screen to grid inputs and outputs, in accordance with some implementations. When an object is selected, e.g., by clicking the object, performing some other type of interaction with the objects to select it the object can be associated with a grid cell and a gesture mapping can be used to map the grid cell to one or from one or more gestures to a gesture that is accepted by the device. The menu shows an index of the grid cell 510, an example input 520 that is to be mapped to the object, and an action 530 that is associated with the type of input. Screen capture 501 shows examples of various grids 550 associated with various states of an active application, for example, the civilian ATAK (CivTAK) application 540, five states are associated with five grids. The set of windows 560 allows for mappings to be edited, the grid to be duplicated or assigned to another application or deleted.

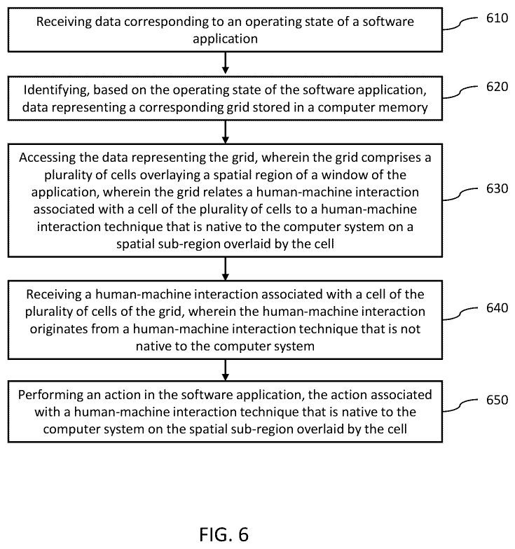

FIG. 6 illustrates a flow diagram of an example process 600 for performing an action associated with a human machine-interaction technique using an interaction translation system (e.g., the interaction translation system 100 shown in FIG. 1), in accordance with some implementations.

In operation 610, the interaction translation system receives data corresponding to an operating state of an active application or another computer program (e.g., operating system) executing on a client device. The active application or software function can be configured to accept one or more types of input from a user. The operating state can be a visual state of the software application. For example, the operating state can be associated with an image including one or more graphical objects associated with a particular sequence of operations input to the application. The operating state can also be associated with a time, or location, an audio signal, a haptic signal, or a combination of any of the preceding examples.

In operation 620, the interaction translation system identifies, based on the operating state of the software application, data representing a corresponding grid stored in a computer memory. The grid can be associated with the operating state or with another state. The grid can be user-generated or generated automatically (e.g., using object recognition) by an application executing on the client device or on another computing device. For example, an application (e.g., the interaction translation application 120) can scan a graphical user interface of an active application (e.g., active application 130), determine visual objects associated with the application state and generate a grid with cells that encompass each of the graphical objects on the screen. A user can manually generate the grid using an application stored on the client device (e.g., the interaction translation application). The application can include a GUI allowing a user to draw a grid using, for example, drag and drop functionality. This functionality can allow the user to control the sizes and shapes of the cells on the grid. The application can also allow the user to store the grid in computer memory or on a database that is accessible via a computer network. The user can use this program to associate the grid with a particular state of a particular application. When that state of the application is registered the computer system can pull the appropriate state from memory.

In operation 630, the interaction translation system accesses the data representing the grid. The grid can include one or more cells overlaying a spatial region of a graphical window of the active application or other computer program (e.g., operating system). The grid can relate a human-machine interaction associated with the cell of the grid to a human-machine interaction technique that is native to the computer system. The cell of the grid can overlay a spatial sub-region (e.g., one or more pixels that are within the spatial region of the graphical window and which are incorporated into a graphical or visual object) of the display of the client device. For example, human touch input is a type of human-machine interaction native to a smartphone. The grid can, for a particular object on the smartphone screen, map the touch screen input to one or more alternative gestures that were not previously accepted by the application. For example, the grid can map a certain type of touch (e.g., a swipe, a touch with one digit, or a touch with two digits) to a keyboard, mouse, or trackball input, a voice command, a non-contact gesture, or another type of human machine interaction. The grid can relate a spatial region to multiple types of actions not previously accepted by the application. For example, an object that was able to be activated by touch can be configured to be activated by both mouse click and voice.

In operation 640, the interaction translation system can receive a human machine interaction associated with a cell. The interaction may not have been previously accepted by the application. For example, the active application may have been configured to accept touchscreen input, but the input received is a mouse click or a voice command. The interaction can originate from a human-machine interaction technique that was not native to the computer system or the application.

In operation 650, the interaction translation system can perform an action on the active application or other computer program. The action can be associated with the human machine interaction technique that is not native to the computer system. The action may include activating a visual object overlaid by the grid cell.

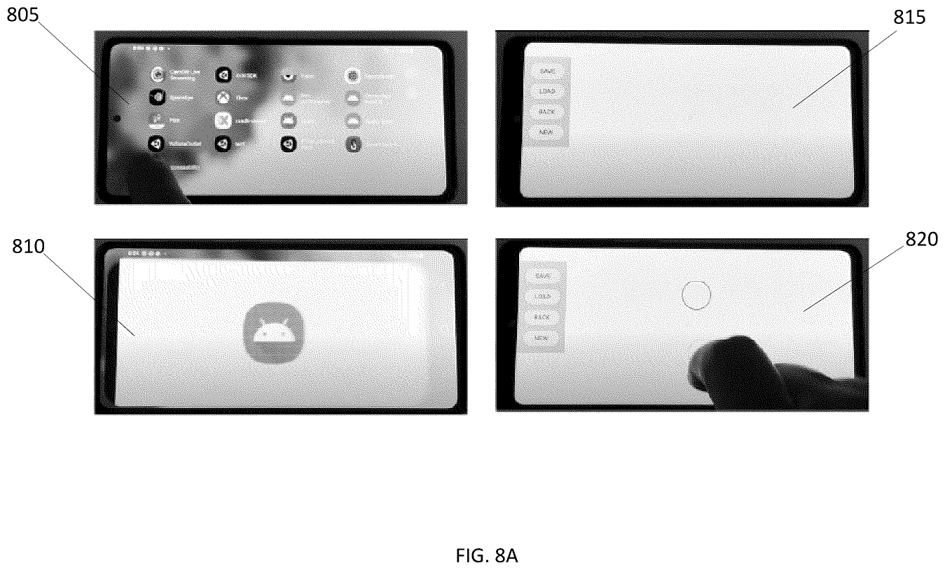

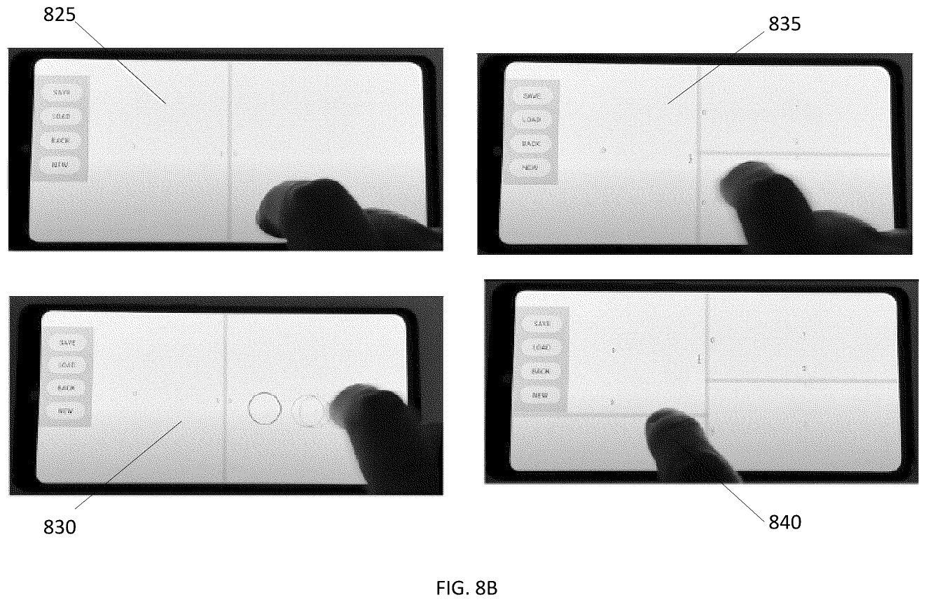

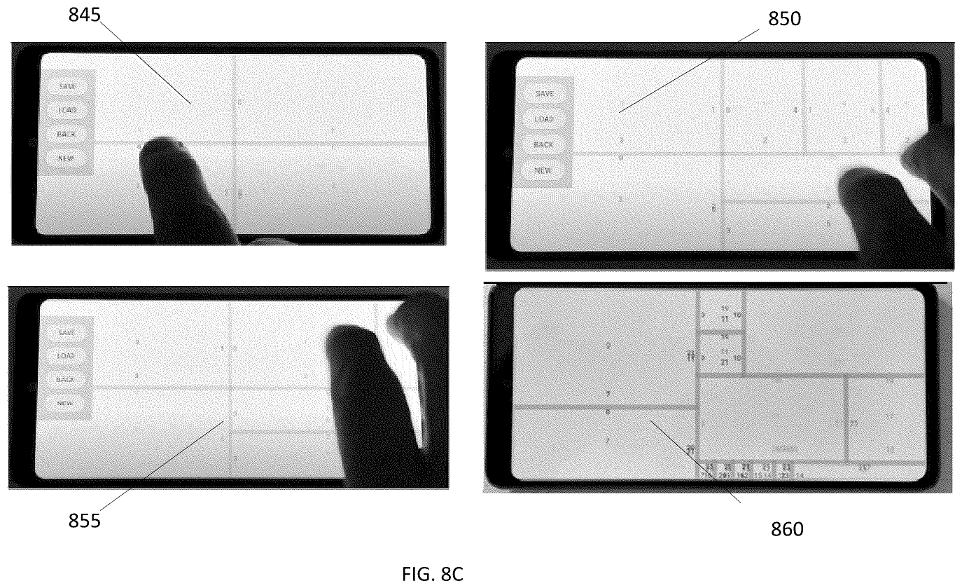

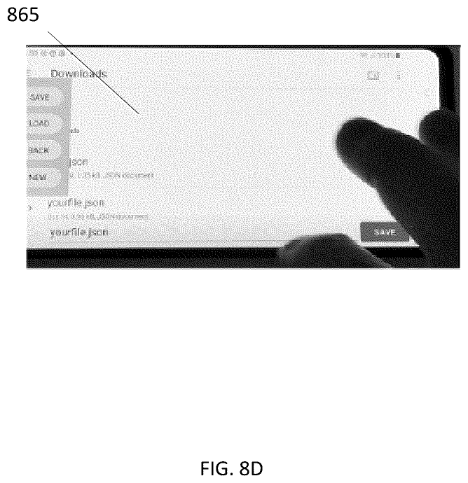

FIGS. 8A-8D illustrate use of an interaction translation application to generate a grid associated with an active application or a state of an application, according to some implementations. A grid can provide a subdivision of a display into desired input areas that can be mapped to HMI inputs. The subdivision can take place in an interaction translation application (e.g., the interaction translation application 120) and grid itself can be invisible (to the user) overlay that can run on the screen while active applications are running. With mapped HMI inputs, a user can emulate a human-machine interaction native to a client device via an HMI input for a cell of the grid.

An interaction translation application can be installed on the client device (805). Upon initial launch, it can load key data files (e.g.., prior grid configurations) and can ensure necessary permissions on a client device (primarily accessibility controls) are enabled (810). When creating a new grid, a user can load in an existing grid to edit it as a new variant, or it can start a new grid from scratch (815). In some implementations, the user navigates out of the application to capture a screenshot of a third-party application to serve as background to help with precision the grid generation. A user can drag vertically (e.g., using a finger, mouse, or stylus) at any point on the screen to create a vertical separation line (820, 825). These lines can split a region into two different grid cells when added. In the image shown, the small annotation numbers may not be visible to end users. A user can slice the whole screen single cells multiple cells either horizontally or vertically. This can allow for an easy and dynamic way to define the grid.

Like the prior images, a user can drag horizontally to segment a given image into two new cells split by the horizontal line added by the user (830, 835). For lines that are already in place users can select and drag to move them along their perpendicular axes (840, 845). When moving lines a snap snapping function can help the user align different lines with each other. Lines can be removed by merging two cells, effectively deleting the line that was dividing them prior to the merge (850, 855). This can be performed by executing a simple multi-touch tap with one finger in each zone to be merged, for example. Handles can be used to adjust lines when there are particularly small regions of the screen where input cells are needed (e.g., on an ATAK icon) (860). A backend system can run locally on the client device to allow for create, read, update, and delete (CRUD) functionality for grids (865), or create, read, update, and/or delete one or more grids. Grids can be defined using a JavaScript Object Notation (JSON) file that exports or inputs from the end user devices folder. This can facilitate creation of multiple grids for a user and can also create the functionality to export grids from a one client device to another.

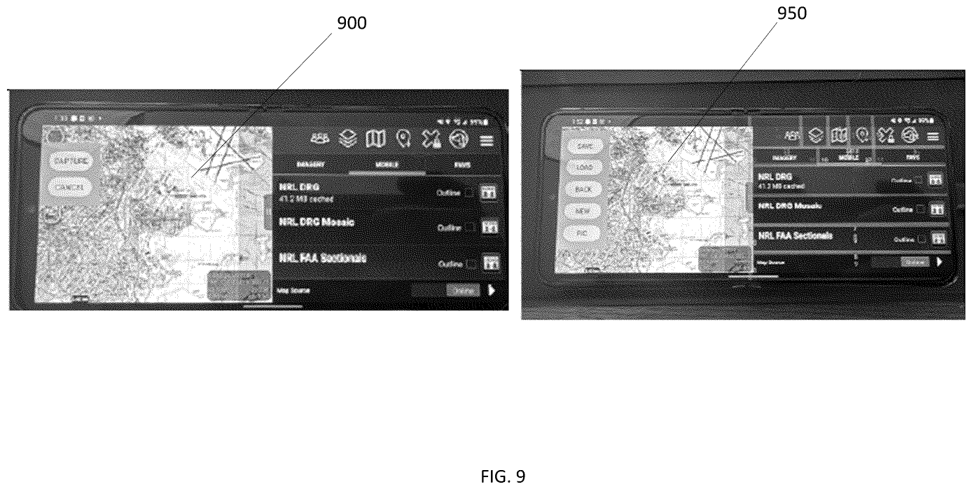

FIG. 9 illustrates screen captures showing the interaction translation application interacting with an active application, in accordance with some implementations. In screen capture 900, the interaction translation application allows a user to switch to screenshot mode where the user can then navigate to any other application running on a client device, put that application in a desired state, and then capture an image of it. This screenshot image can be then ported back into a grid design interface so the user can overlay the grid on top of the image to align it for interaction regions that make sense for the active application. Screen capture 950 occurs sequentially from screen capture 900. In screen capture 950, a grid has been configured on top of the active application (e.g., civilian ATAK [CivTAK]), creating bounding boxes for user interactions over key regions and icons within the active application GUI.

### User Workflows

The following subsections describe a set of user workflows to accomplish the main interaction translation application functionalities that configure interaction translation application for use, in accordance with some embodiments. The list of workflows should not be construed to limit any preceding aspect of this disclosure.

### Grid Generation

User opens the Interaction translation application.

User prompts generation of a grid.

User directed to select the application from a list of installed applications or software packages that the grid will be used with.

User directed to navigate to the running application in the desired GUI state and snap a screenshot, then return to interaction translation application.

The interaction translation system detects the recent screenshot when the user reactivates the application, and automatically pastes the image into the background of the grid creation GUI.

The grid defaults to a single cell that covers the full screen outline.

User can add or remove rows and columns to the grid to define the grid.

User can tap on a particular row or column (tap once in a cell to select the row, tap twice to select the column) to be given user interface (UI) handle elements to adjust the width of the row or column.

When a row or column is in the correct position on the screen, the user can select a lock option to lock that row or column in place (e.g., while they then go edit other rows and columns).

After all rows or columns have been locked in place, the user can save the grid.

When saving the grid, the user can define an alphanumeric name for the grid.

After creation, when a grid is active, it is transparent on the client screen when viewing it with the active application as long as the interaction translation application service is running in the background.

### Grid HMI-P Input Mapping

After a grid has been saved, the user can select it in the interaction translation application to map HMI-P inputs to specific cells of the grid.

After selecting a grid to map HMI-P inputs, the user can select which connected (via USB-C or Bluetooth) peripheral they want to use. This selection is done based on a list of available and/or compliant HMI-P devices that are actively connected to the client device.

After selecting the HMI-P to use, the user then can select any single cell from the grid.

Once a cell is selected, a listener can be activated, and the user can activate the input on the HMI-P device. If the activation is detected, it can then register and show what input was detected and assign it to that cell.

The user can select a cell with an input function and overwrite it or remove it.

Only one input from a given HMI-P device can be mapped to a given grid cell; however, a user can select different HMI-P devices and map their respective inputs to the same cell. For example, a user could activate cell A4 using a gesture glove input and a keyboard press, but a user could not have two different keyboard buttons mapped to the same A4 cell.

After all desired input mappings for a given HMI-P have been added, the user can save the mapping and it becomes associated with the grid.

### Grid Duplication

After a grid has been saved, the user can select it to duplicate the grid and any HMI-P input mappings that have been made.

The user navigates to the given grid they wish to duplicate (which requires selecting the active application it is nested under) and then selects it.

The user can then have an option to duplicate the grid. When selected, the user can be first prompted to select an active application that the duplicate will be assigned to. This can be any active application the user has previously associated a grid to (including the same active application the grid is already nested under) or any application that is detected as actively running on the client device).

When the grid is copied it carries over any HMI-P mappings that exist, as well as any ACA mapping definitions.

### Grid Automatic Contextual Adaptation (ACA) Mapping

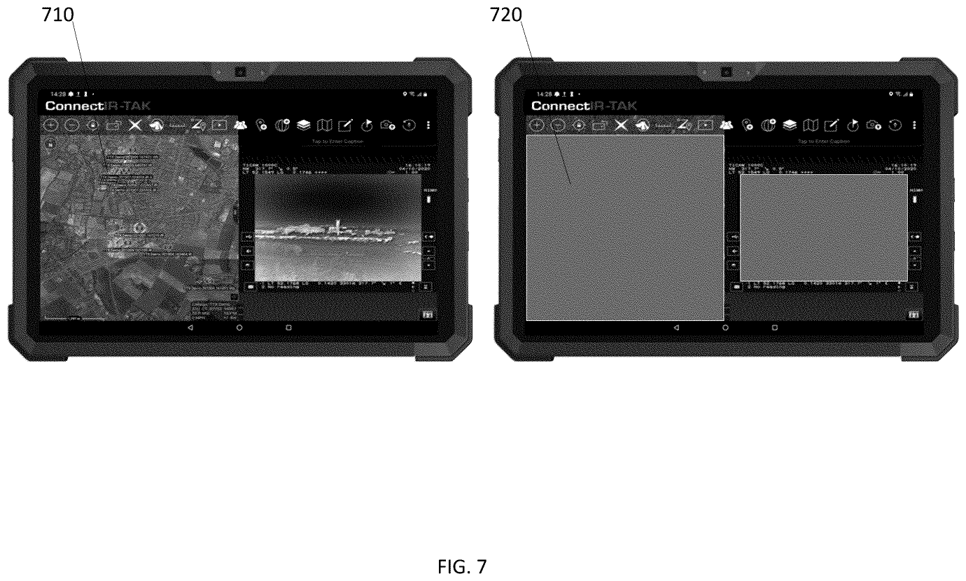

FIG. 7 illustrates screen captures of an ACA mapping process, in accordance with some implementations.

After a grid has been created, a user can set up automated detection of the contextual state in the active application where that grid should be activated.

By having grids nested under active applications, this means ACA for a given grid only exists within the parent application.

The user can be first asked to capture an annotated screenshot of the application in the desired GUI State. This is done by allowing the user to bring up the active application, capturing a screenshot, and then switching back to the interaction translation application, which then detects the screenshot and imports it.

After the screenshot is imported, the user can be prompted to blackout any regions of the GUI that may be inconsistent or variable when viewing the target GUI State. This can be done by adding resizable geometric shapes such as rectangles and ellipses overlaid on the screenshot. The user can tap the screen to add a new geometry and then use resizing handles to change size of the geometry or tap the center of the shape and drag to reposition it on the screen. Screen capture 710 shows ATAK with the primary map on the left of the client device display and an infrared (IR) video feed on the right. Screen capture 720 shows an example of how a user can annotate this screenshot to highlight that the map contents and the video feed contents will frequently change and, as such, should not be used to detect the GUI State.

After defining the GUI State screenshot, the user can save the GUI State and can then enter a “test mode.” In this test mode, the user can navigate the active application and carry out whatever actions they wish within the native active application. Whenever the interaction translation application detects the target GUI State, it can play a notification tone. This can allow the user to confirm that the system is in fact reliably detecting the GUI State.

In some implementations, additional refinement steps are added to further constrain the GUI State detection to increase performance.

### Grid Management

The user can view created grids at a per-application level.

The user can select a given grid associated with an application to assign it as the default grid for the application on launch, adjust its grid layout, CRUD HMI-P input mappings, duplicate it, migrate it to a new application completely, delete it, or assign a new ACA annotated screenshot.

### System Level Settings/Configuration

The user can define one or more HMI-P inputs that globally lock or unlock interaction translation application touchscreen emulation inputs. lock and unlock can be the same HMI-P input(s) or different based on user preference.

The user can define what feedback they want to receive (if any) when interaction translation application automatically changes the active grid (via contextual adaptation). Options would be for the system to play a tone, trigger an operating system notification, vibrate the phone, or (if linked) trigger a beacon device vibration or visual cue.

Export all grids. This option can allow the user to generate a JSON or similar file to export all defined grids so they can be migrated to a new client device.

Import grids. This option can allow a user to load a local or secure digital (SD) card export file that then adds all defined grids from the export to the client device interaction translation application installation. This would overwrite any grids with the same alphanumeric name or identifier using the imported grids.

The user can have the per-application-level ability to toggle ACA on or off.

The user can have the global ability to toggle ACA on or off. The user can have the ability to adjust the global ACA GUI state persistence duration (default: one second) that defines how long a GUI State should be on the screen before an automatic switch to the associated grid takes place.

In some embodiments, the system further includes a voice-input mapping module configured to associate user-specified spoken command terms with one or more action cells of the touchscreen translation grid. The module receives speech input from any external speech-recognition engine, without restriction to a specific vendor or model, and converts recognized command terms into standardized input events. The system processes these speech-derived input events in the same manner as inputs received from other human-machine interface peripherals, enabling the execution of the corresponding grid-mapped touchscreen actions. This architecture permits the system to remain speech-detection-engine agnostic, such that any compatible speech-to-text service (including but not limited to OpenAI Whisper models) may be used to generate the recognized command terms.

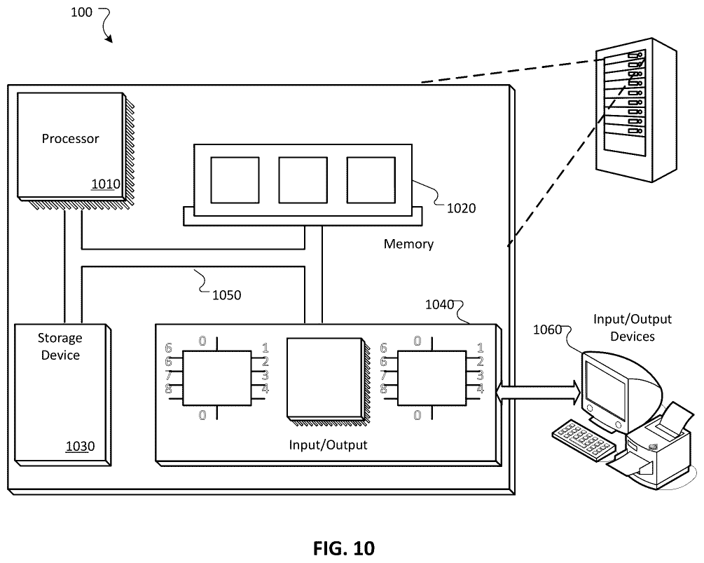

FIG. 10 is a block diagram of an example computer system 1000. For example, FIG. 1 could be an example of the system 1000 described here, as could a computer system used by any of the users who implements or uses an interaction translation system. The system 1000 includes a processor 1010, a memory 1020, a storage device 1030, and one or more input/output interface devices 1040. Each of the components 1010, 1020, 1030, and 1040 can be interconnected, for example, using a system bus 1050.

The processor 1010 is capable of processing instructions for execution within the system 1000. The term “execution” as used here refers to a technique in which program code causes a processor to carry out one or more processor instructions. In some implementations, the processor 1010 is a single-threaded processor. In some implementations, the processor 1010 is a multi-threaded processor. In some implementations, the processor 1010 is a quantum computer. The processor 1010 is capable of processing instructions stored in the memory 1020 or on the storage device 1030. The processor 1010 may execute operations such as translating human-computer interactions.

The memory 1020 stores information within the system 1000. In some implementations, the memory 1020 is a computer-readable medium. In some implementations, the memory 1020 is a volatile memory unit. In some implementations, the memory 1020 is a non-volatile memory unit.

The storage device 1030 is capable of providing mass storage for the system 1000. In some implementations, the storage device 1030 is a non-transitory computer-readable medium. In various different implementations, the storage device 1030 can include, for example, a hard disk device, an optical disk device, a solid-state drive, a flash drive, magnetic tape, or some other large capacity storage device. In some implementations, the storage device 1030 may be a cloud storage device, e.g., a logical storage device including one or more physical storage devices distributed on a network and accessed using a network, such as the network shown in FIG. 1. The input/output interface devices 1040 provide input/output operations for the system 1000. In some implementations, the input/output interface devices 1040 can include one or more of a network interface device, e.g., an Ethernet interface, a serial communication device, e.g., an RS-232 interface, and/or a wireless interface device, e.g., an 802.11 interface, a 3G wireless modem, a 10G wireless modem, etc. A network interface device allows the system 1000 to communicate, for example, transmit and receive data such as stored grids. In some implementations, the input/output device can include driver devices configured to receive input data and send output data to other input/output devices, e.g., keyboard, printer and display devices 1060. In some implementations, mobile computing devices, mobile communication devices, and other devices can be used.

Referring to FIG. 1, the interaction translation system components can be realized by instructions that upon execution cause one or more processing devices to carry out the processes and functions described above, for example, generating grids that can be overlaid in active applications. Such instructions can include, for example, interpreted instructions such as script instructions, or executable code, or other instructions stored in a computer readable medium.

An interaction translation system as shown in FIG. 1 can be distributively implemented over a network, such as a server farm, or a set of widely distributed servers or can be implemented in a single virtual device that includes multiple distributed devices that operate in coordination with one another. For example, one of the devices can control the other devices, or the devices may operate under a set of coordinated rules or protocols, or the devices may be coordinated in another fashion. The coordinated operation of the multiple distributed devices presents the appearance of operating as a single device.

In some examples, the system 1000 is contained within a single integrated circuit package. A system 1000 of this kind, in which both a processor 1010 and one or more other components are contained within a single integrated circuit package and/or fabricated as a single integrated circuit, is sometimes called a microcontroller. In some implementations, the integrated circuit package includes pins that correspond to input/output ports, e.g., that can be used to communicate signals to and from one or more of the input/output interface devices 1040.

Although an example processing system has been described in FIG. 10, implementations of the subject matter and the functional operations described above can be implemented in other types of digital electronic circuitry, or in computer software, firmware, or hardware, including the structures disclosed in this specification and their structural equivalents, or in combinations of one or more of them. Implementations of the subject matter described in this specification, such as storing, maintaining, and displaying artifacts can be implemented as one or more computer program products, i.e., one or more modules of computer program instructions encoded on a tangible program carrier, for example a computer-readable medium, for execution by, or to control the operation of, a processing system. The computer readable medium can be a machine-readable storage device, a machine readable storage substrate, a memory device, or a combination of one or more of them.

The term “system” may encompass all apparatus, devices, and machines for processing data, including by way of example a programmable processor, a computer, or multiple processors or computers. A processing system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, executable logic, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Computer readable media suitable for storing computer program instructions and data include all forms of non-volatile or volatile memory, media and memory devices, including by way of example semiconductor memory devices, e.g., EPROM, EEPROM, and flash memory devices; magnetic disks, e.g., internal hard disks or removable disks or magnetic tapes; magneto optical disks; and CD-ROM, DVD-ROM, and Blu-Ray disks. The processor and the memory can be supplemented by, or incorporated in, special purpose logic circuitry. Sometimes a server (e.g., HCP data server as shown in FIG. 10) is a general-purpose computer, and sometimes it is a custom-tailored special purpose electronic device, and sometimes it is a combination of these things. Implementations can include a back end component, e.g., a data server, or a middleware component, e.g., an application server, or a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network such as the network shown in FIG. 1. Examples of communication networks include a local area network (“LAN”) and a wide area network (“WAN”), e.g., the Internet.

In the descriptions above and in the claims, phrases such as “at least one of” or “one or more of” can occur followed by a conjunctive list of elements or features. The term “and/or” can also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows can include different and/or additional operations than shown without departing from the scope of the present disclosure. One or more operations of the logic flows can be repeated and/or omitted without departing from the scope of the present disclosure. Other implementations can be within the scope of the following claims.

What is claimed is:

1. A method performed by a computer system, comprising:
receiving data corresponding to an operating state of a software application;
identifying, based on the operating state of the software application, data representing a corresponding grid stored in a computer memory;
accessing the data representing the grid, wherein the grid comprises a plurality of cells overlaying a spatial region of a window of the software application, wherein the grid relates a human-machine interaction associated with a cell of the plurality of cells to a human-machine interaction technique that is native to the computer system on a spatial sub-region overlaid by the cell;
receiving a human-machine interaction associated with a cell of the plurality of cells of the grid, wherein the human-machine interaction originates from a human-machine interaction technique that is not native to the computer system; and
performing an action in the software application, the action associated with a human-machine interaction technique that is native to the computer system on the spatial sub-region overlaid by the cell.

2. The method of claim 1, wherein the human-machine interaction technique that is native to the computer system is a touch input.

3. The method of claim 2, wherein the touch input is a tap, hold, or swipe with one or more digits or stylus.

4. The method of claim 1, wherein the software application comprises a mobile application executed on a mobile device.

5. The method of claim 1, wherein the operating state of the software application comprises a screen capture image, software accessible operating system or application state information, a global positioning system (GPS) location, a time, or any combination of such.

6. The method of claim 1, wherein the operating state of the software application is corresponded with the grid using a machine learning model.

7. The method of claim 1, wherein a cell of the plurality of cells of the grid are rectangular in shape.

8. The method of claim 1, wherein at least a first cell of the plurality of cells of the grid is larger in size than at least a second cell of the grid.

9. The method of claim 1, wherein the human-machine interaction comprises a use of an input device.

10. The method of claim 9, wherein the input device comprises a mouse, keyboard, controller, trackball, tablet, or touchscreen.

11. The method of claim 1, wherein the human-machine interaction comprises a bodily movement, physiological state, or gesture.

12. The method of claim 11, wherein the bodily movement or gesture comprises a hand movement, foot movement, a mouth movement or an eye movement.

13. The method of claim 1, wherein the human-machine interaction comprises audio.

14. The method of claim 13, wherein the audio is human speech.

15. The method of claim 1, wherein the grid is generated via human input to a graphical user interface (GUI).

16. The method of claim 1, wherein the grid is generated automatically at least in part by performing object recognition on a graphical state of the software application.

17. The method of claim 1, wherein the operating state of the application is defined via human input to a graphical user interface (GUI).

18. The method of claim 1, wherein a cell of the plurality of cells is associated with at least two human-machine interactions.

19. The method of claim 18, wherein at least a first human-machine interaction of the at least two human-machine interactions comprises a bodily movement or gesture, and wherein at least a second human-machine interaction of the at least two human-machine interactions comprises a use of an input device.

20. The method of claim 1, comprising:
receiving one or more user-specified spoken command terms via a speech recognition engine;
interpreting the one or more spoken command terms as standardized input events independent of a specific speech-recognition engine utilized; and
mapping the standardized input events to one or more of the cells for execution of one or more corresponding touchscreen actions.

21. The method of claim 20, wherein the one or more user-specified spoken command terms correspond to user-defined actions associated with one or more of the cells.

22. The method of claim 21, wherein the user-defined actions include one or more gesture-based touchscreen interactions.

23. A system, comprising:
a processor;
a memory storing instructions that, when executed by the processor, cause the system to carry out operations comprising:
receiving data corresponding to an operating state of a software application;
identifying, based on the operating state of the software application, data representing a corresponding grid stored in a computer memory;
accessing the data representing the grid, wherein the grid comprises a plurality of cells overlaying a spatial region of a window of the software application, wherein the grid relates a human-machine interaction associated with a cell of the plurality of cells to a human-machine interaction technique that is native to the computer system on a spatial sub-region overlaid by the cell;
receiving a human-machine interaction associated with a cell of the plurality of cells of the grid, wherein the human-machine interaction originates from a human-machine interaction technique that is not native to the computer system; and
performing an action in the software application, the action associated with a human-machine interaction technique that is native to the computer system on the spatial sub-region overlaid by the cell.

24. A non-transitory computer-readable medium storing instructions that, when executed by one or more processors of a computer system, cause the computer system to perform operations comprising:
receiving data corresponding to an operating state of a software application;
identifying, based on the operating state of the software application, data representing a corresponding grid stored in a computer memory;
accessing the data representing the grid, wherein the grid comprises a plurality of cells overlaying a spatial region of a window of the software application, wherein the grid relates a human-machine interaction associated with a cell of the plurality of cells to a human-machine interaction technique that is native to the computer system on a spatial sub-region overlaid by the cell;
receiving a human-machine interaction associated with a cell of the plurality of cells of the grid, wherein the human-machine interaction originates from a human-machine interaction technique that is not native to the computer system; and
performing an action in the software application, the action associated with a human-machine interaction technique that is native to the computer system on the spatial sub-region overlaid by the cell.

25. A method performed by a computer system, comprising:
receiving, at an interaction translation application executing on a client device, a screenshot image of a graphical user interface (GUI) of an active application executing on the client device, the screenshot image representing a target GUI state of the active application;
receiving, via the interaction translation application, user input annotating one or more regions of the screenshot image to be excluded from GUI state detection, the one or more regions corresponding to variable content within the target GUI state;
storing the annotated screenshot image in association with a grid configured for the target GUI state, the grid comprising a plurality of cells overlaying a spatial region of the GUI of the active application;
during execution of the active application, comparing a current GUI state of the active application to the annotated screenshot image while excluding the annotated one or more regions from the comparison; and
responsive to detecting that the current GUI state matches the target GUI state based on the comparison, automatically activating the grid associated with the target GUI state to enable human-machine interaction inputs mapped to cells of the grid.

26. The method of claim 25, wherein the user input annotating the one or more regions comprises adding resizable geometric shapes overlaid on the screenshot image, the geometric shapes including rectangles or ellipses positioned over the variable content.
